(19) United States
(12) Patent Application Publication
(10) Pub. No.: US 2011/0311437 A1
(43) Pub. Date: Dec. 22, 2011

(54) METHOD FOR PRODUCING SPINEL-TYPE LITHIUM MANGANATE

(75) Inventors: Yukinobu YURA, Nagoya-city (JP); Nobuyuki KOBAYASHI, Nagoya-city (JP); Tsutomu NANATAKI, Toyoake-city (JP); Kazuyuki KAIGAWA, Kitanagoya-city (JP); Ryuta SUGIURA, Nagoya-city (JP)

(73) Assignee: NGK Insulators, Ltd., Nagoya-City (JP)

(21) Appl. No.: 13/165,307

(22) Filed: Jun. 21, 2011

Related U.S. Application Data
(60) Provisional application No. 61/375,400, filed on Aug. 20, 2010.

(30) Foreign Application Priority Data
Jun. 21, 2010 (JP) PCT/JP2010/060927

(51) Int. Cl. C01D 15/00

(52) U.S. Cl. 423/599

(57) ABSTRACT

The production method of the present invention includes (A) a forming step of forming into a sheet-like compact a raw material containing at least a manganese compound and not containing a lithium compound; (B) a first firing step of firing the sheet-like compact formed through the forming step; and (C) a second firing step of firing a mixture of the fired compact obtained through the first firing step and a lithium compound at a temperature lower than the firing temperature employed in the first firing step.

### BACKGROUND OF THE INVENTION

1. Field of the Invention

The present invention relates to a method for producing spinel-type lithium manganate, which is an oxide containing at least lithium and manganese as constituent elements and having a spinel structure.

2. Description of the Related Art

Such spinel-type lithium manganate is known as a cathode active material for a lithium secondary battery (may be referred to as a “lithium ion secondary battery”) (see, for example, Japanese Patent Application Laid-Open (kokai) Nos. H11-171551, 2000-30707, 2006-252940, and 2007-294119). In contrast to a cathode active material formed of a cobalt oxide or a nickel oxide, a cathode active material formed of spinel-type lithium manganate has the following features: high safety, high rate characteristics, and low cost.

### SUMMARY OF THE INVENTION

However, a cathode active material of spinel-type lithium manganate poses problems in terms of durability, including deterioration of cycle characteristic at high temperature, and deterioration of storage characteristics at high temperature. An effective approach to solve such a problem is, for example, formation of large-sized cathode active material particles of spinel-type lithium manganate (e.g., formation of particles having a size of 10 μm or more) (see, for example, paragraph [0005] of Japanese Patent Application Laid-Open (kokai) No. 2003-109592).

Upon production of cathode active material particles of spinel-type lithium manganate, generally, grain growth is promoted through firing at high temperature, whereby large-sized particles are obtained. When firing is carried out at excessively high temperature, spinel-type lithium manganate releases oxygen and is decomposed into lithium manganate having a layered rock salt structure, and manganese oxide. During temperature drop, the thus-decomposed substances absorb oxygen and are restored to spinel-type lithium manganate. However, particles which have undergone such a process have many oxygen defects, resulting in deterioration of characteristics (e.g., cell capacity).

Thus, conventional methods have failed to industrially (i.e., stably) produce spinel-type lithium manganate particles which are suitable for use as a cathode active material for a lithium secondary battery, which exhibit excellent characteristics (i.e., contain few impurities and defects), and which exhibit high durability.

As used herein, “spinel-type lithium manganate, which is an oxide containing at least lithium and manganese as constituent elements and having a spinel structure,” which is produced through the method of the present invention, is not limited to that represented by the formula LiMn₂O₄. Specifically, the present invention is suitably applied to a compound represented by the following formula (1) and having a spinel structure.

LiMₓMn₂₋ₓO₄ (1)

In formula (1), M represents at least one element (substitution element) selected from the group consisting of Li, Fe, Ni, Mg, Zn, Al, Co, Cr, Si, Sn, P, V, Sb, Nb, Ta, Mo, and W. The substitution element M may include Ti, Zr, or Ce in addition to the aforementioned at least one element.

In formula (1), x (0 to 0.55) corresponds to the proportion of the substitution element M. Li is a monovalent cation; Fe, Mn, Ni, Mg, or Zn is a divalent cation; B, Al, Co, or Cr is a trivalent cation; Si, Ti, Sn, Zr, or Ce is a tetravalent cation; P, V, Sb, Nb, or Ta is a pentavalent cation; and Mo or W is a hexavalent cation. Theoretically, any of these elements forms a solid solution with LiMn₂O₄.

When, for example, M is Li, and x is 0.1, the compound of formula (1) is represented by the following chemical formula (2). When M is Li and Al (M1=Li, M2=Al), and x is 0.08 and 0.09 (i.e., x1 [Li]=0.08, x2[Al]=0.09), the compound of formula (1) is represented by the following chemical formula (3).

Li_{1.1}Mn_{1.9}O₄ (2)

Li_{1.08}Al_{0.9}Mn_{1.83}O₄ (3)

Co or Sn may be a divalent cation; Fe, Sb, or Ti may be a trivalent cation; Mn may be a trivalent or tetravalent cation; and Cr may be a tetravalent or hexavalent cation. Therefore, the substitution element M may have a mixed valency. The atomic proportion of oxygen is not necessarily 4. So long as the compound of formula (1) can maintain a crystal structure, the atomic proportion of oxygen may be less than or greater than 4.

Substitution of 25 to 55 mol % of Mn by Ni, Co, Fe, Cu, Cr, etc. realizes production of a cathode active material which can be employed for producing a lithium secondary battery exhibiting excellent high-temperature cycle characteristic and rate characteristic. Also, in such a case, energy density can be increased by elevating charge/discharge potential, and thus a lithium secondary battery having an electromotive force as high as 5 V can be produced.

Thus, spinel-type lithium manganate which is produced through the method of the present invention has a spinel structure and is represented by the following formula (4):

Li₁₊ₐM_{y}Mn_{2-a-y}O_{4-σ} (4)

(wherein 0≦y≦0.5, 0≦a≦0.3, 0≦σ≦0.05).

The production method of the present invention comprises:

(A) a forming step of forming into a sheet-like compact a raw material containing at least a manganese compound and not containing a lithium compound;

(B) a first firing step of firing the sheet-like compact formed through the forming step; and

(C) a second firing step of firing a mixture of the fired compact obtained through the first firing step and a lithium compound at a temperature lower than the firing temperature employed in the first firing step.

Specifically, for example, the first firing step is carried out at a firing temperature of 1,000 to 1,300° C., and the second firing step is carried out at a firing temperature of 500 to 800° C.

When a portion of manganese is substituted by a substitution element M other than lithium, the aforementioned raw material contains a manganese compound and a compound of the substitution element M. The raw material may further contain a grain growth promoting aid having a melting point lower than the firing temperature employed in the first firing step.

In the production method of the present invention, firstly, a raw material containing at least a manganese compound and not containing a lithium compound is formed into a sheet-like compact through the forming step.

Subsequently, the sheet-like compact is fired through the first firing step at a relatively high temperature, to thereby form large-sized grains of manganese oxide (Mn₃O₄) into which lithium has not yet been incorporated. Since the above-formed sheet-like compact is fired through the first firing step, grain growth in a thickness direction of the compact can be controlled. Through this firing step, almost the entire surface of the compact is formed by the surfaces of crystal grains, and thus oxygen is readily incorporated into the grains. Therefore, a favorable crystalline product having oxygen defects in as small an amount as possible can be synthesized.

Thereafter, a mixture of the thus-fired compact and a lithium compound is fired (thermally treated) through the second firing step at a relatively low temperature, to thereby incorporate lithium into the fired compact. Thus, spinel-type lithium manganate having a large particle size can be produced while occurrence of oxygen defects is suppressed to a minimum possible extent.

As described above, according to the production method of the present invention, in which the sheet-like compact is subjected to so-called two-step firing (provisional firing and thermal treatment for lithium incorporation), occurrence of oxygen defects can be suppressed to a minimum possible extent by causing oxygen to be easily incorporated into crystal grains, and the resultant particles exhibit excellent characteristics and high durability, as compared with conventional cases (including the case of particles which are obtained only through two-step firing without being subjected to a sheet forming step). Thus, the production method of the present invention can industrially (i.e., stably) produce spinel-type lithium manganate particles which are suitable for use as a cathode active material for a lithium secondary battery, which exhibit excellent characteristics, and which exhibit high durability.

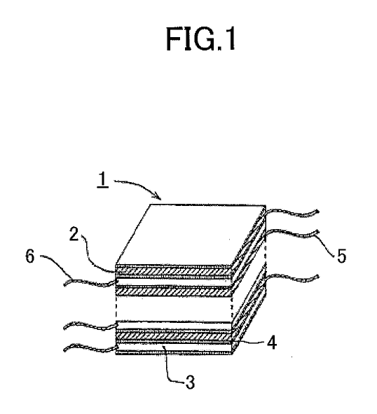

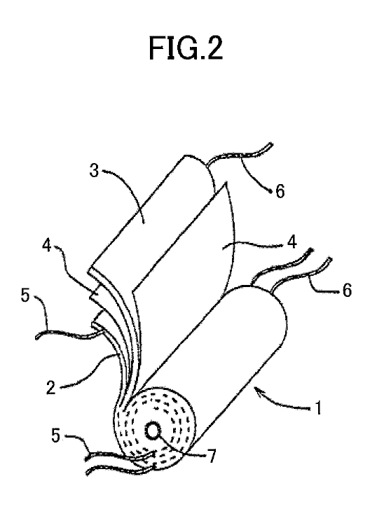

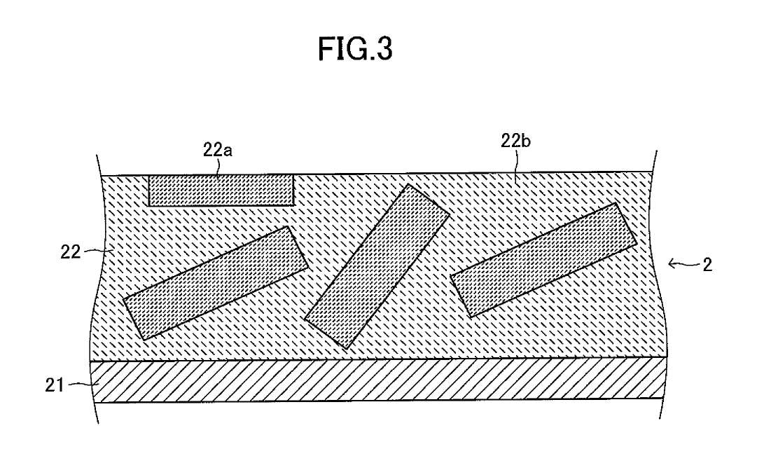

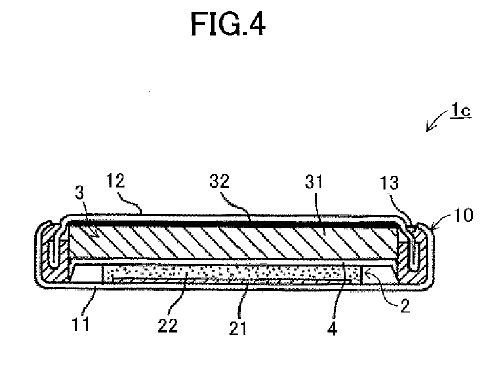

### BRIEF DESCRIPTION OF THE DRAWINGS

[FIG. 1] Sectional view of the schematic configuration of an example lithium secondary battery to which one embodiment of the present invention is applied.

[FIG. 2] Perspective view of the schematic configuration of another example lithium secondary battery to which one embodiment of the present invention is applied.

[FIG. 3] Enlarged sectional view of the cathode plate shown in FIG. 1 or 2.

[FIG. 4] Side sectional view of the schematic configuration of a coin cell for evaluating spinel-type lithium manganate particles (cathode active material particles shown in FIG. 3) produced through one embodiment of the production method of the present invention.

### DETAILED DESCRIPTION OF THE PREFERRED EMBODIMENTS

Preferred embodiments of the present invention will next be described with reference to examples and comparative examples. The following description of the embodiments is nothing more than the specific description of mere example embodiments of the present invention to the possible extent in order to fulfill description requirements (descriptive requirement and enabling requirement) of specifications required by law.

Thus, as will be described later, naturally, the present invention is not limited to the specific configurations of embodiments and examples to be described below. Modifications that can be made to the embodiments and examples are collectively described herein at the end to a maximum possible extent, since insertion thereof into the description of the embodiments would disturb understanding of consistent description of the embodiments.

### 1. Configuration of Lithium Secondary Battery

FIG. 1 is a sectional view of the schematic configuration of an example lithium secondary battery 1 to which one embodiment of the present invention is applied. Referring to FIG. 1, the lithium secondary battery 1 is a so-called liquid-type battery and includes cathode plates 2, anode plates 3, separators 4, cathode tabs 5, and anode tabs 6.

The separator 4 is provided between the cathode plate 2 and the anode plate 3. That is, the cathode plate 2, the separator 4, and the anode plate 3 are stacked in this order. The cathode tabs 5 are electrically connected to the respective cathode plates 2. Similarly, the anode tabs 6 are electrically connected to the respective anode plates 3.

The lithium secondary battery 1 shown in FIG. 1 is configured such that a stack of the cathode plates 2, the separators 4, and the anode plates 3, and an electrolytic solution containing a lithium compound as an electrolyte are liquid-tightly sealed in a specific cell casing (not illustrated).

FIG. 2 is a perspective view of the schematic configuration of another example lithium secondary battery 1 to which one embodiment of the present invention is applied. Referring to FIG. 1, this lithium secondary battery 1 is also a liquid-type battery and includes a cathode plate 2, an anode plate 3, separators 4, cathode tabs 5, anode tabs 6, and a core 7.

The lithium secondary battery 1 shown in FIG. 2 is configured such that an internal electrode body formed through winding, onto the core 7, of a stack of the cathode plate 2, the separators 4, and the anode plate 3, and the aforementioned electrolytic solution are liquid-tightly sealed in a specific cell casing (not illustrated).

FIG. 3 is an enlarged sectional view of the cathode plate 2 shown in FIG. 1 or 2. Referring to FIG. 3, the cathode plate 2 includes a cathode current collector 21 and a cathode layer 22. The cathode layer 22 is configured such that cathode active material particles 22a are dispersed in a binder 22b. The cathode active material particles 22a are crystal particles (primary particles) of spinel-type lithium manganate having a large particle size (specifically, a maximum size of 10 μm or more).

### 2. Summary of Method for Producing Cathode Active Material Particles

The cathode active material particles 22a shown in FIG. 3 are produced through a production method including the following four steps: (i) forming step, (ii) first firing step, (iii) crushing and classification step, and (iv) second firing step.

(i) Forming Step

Firstly, there are provided raw material powder particles containing at least a manganese compound and not containing a lithium compound (a lithium compound is added in the below-described second firing step). When manganese is substituted by an element other than lithium, the raw material powder particles contain, for example, an aluminum compound, a magnesium compound, a nickel compound, a cobalt compound, a titanium compound, a zirconium compound, a cerium compound, or a chromium compound.

If necessary, the raw material powder particles may be crushed. The powder particles preferably have a size of 10 μm or less. When the powder particles have a size of more than 10 μm, the powder particles may be dry- or wet-crushed so as to attain a size of 10 μm or less. No particular limitation is imposed on the crushing method, and crushing may be carried out by means of, for example, a pot mill, a bead mill, a hammer mill, or a jet mill.

The lithium compound employed may be, for example, Li₂CO₃, LiNO₃, LiOH, Li₂O₂, Li₂O, CH₃COOLi, Li(OCH₃), Li(OC₂H₅), Li(OC₃H₇), Li(OC₄H₉), Li(C₁₁H₁₉O₂), Li₂C₂O₄, or LiCl. The manganese compound employed may be, for example, MnO₂, MnO, Mn₂O₃, Mn₃O₄, MnCO₃, MnOOH, Mn(OCH₃)₂, Mn(OC₂H₅)₂, Mn(OC₃H₇)₂, MnC₂O₄, Mn(CH₃COO)₂, MnCl₂, or Mn(NO₃)₂.

When manganese is substituted by an element other than lithium, the aluminum compound employed may be, for example, α-Al₂O₃, γ-Al₂O₃, AlOOH, Al(OH)₃, Al(OCH₃)₃, Al(OC₂H₅)₃, Al(OC₃H₇)₃, Al(OC₄H₉)₃, AlOCl, or Al(NO₃)₃. The magnesium compound employed may be, for example, MgO, Mg(OH)₂, MgCO₃, Mg(OCH₃)₂, Mg(OC₂H₅)₂, Mg(OC₃H₇)₂, Mg(OC₄H₉)₂^{,} Mg(C₁₁H₁₉O₂)₂, MgCl₂, Mg(C₂H₃O₂)₂, Mg(NO₃)₂, or MgC₂O_{4.}

The nickel compound employed may be, for example, NiO, Ni(OH)₂, NiNO₃, Ni(C₂H₃O₂)₂, NiC₂O₄, NiCO₃, or NiCl₂. The cobalt compound employed may be, for example, Co₃O₄, CoO, Co(OH)₃, CoCO₃, CoC₂O₄, CoCl₂, Co(NO₃)₂, or Co(OC₃H₇)₂. The titanium compound employed may be, for example, TiO, TiO₂, Ti₂O₃, Ti(OCH₃)₄, Ti(OC₂H₅)₄, Ti(OC₃H₇)₄, Ti(OC₄H₉)₄, or TiCI₄. The zirconium compound employed may be, for example, ZrO₂, Zr(OH)₄, ZrO(NO₃)₂, Zr(OCH₃)₄, Zr(OC₂H₅)₄, Zr(OC₃H₇)₄, Zr(OC₄H₉)₄, or ZrOCl₂. The cerium compound employed may be, for example, CeO₂, Ce(OH)₄, or Ce(NO₃)₃. The chromium compound employed may be, for example, Cr₂O₃ or Cr(OH)₃.

The raw material powder particles may optionally contain a grain growth promoting aid (flux aid or low-melting-point aid). The grain growth promoting aid employed may be, for example, a low-melting-point oxide, chloride, boride, carbonate, nitrate, hydroxide, oxalate, or acetate, an alkoxide, or a permanganate.

Specifically, the grain growth promoting aid employed may be any of the following: NaCl, NaClO₃, Na₂B₄O₇, NaBO₂, Na₂CO₃, NaHCO₃, NaNO₃, NaOH, Na₂C₂O₄, NaOCH₃, NaOC₂H₅, NaOC₃H₇, NaOC₄H₉, KCl, K₂B₄O₇, K₂CO₃, KNO₃, KOH, K₂C₂O₄, KOCH₃, KOC₂H₅, KOC₃H₇, KOC₄H₉, K(C₁₁H₁₉O₂), CaCl₂, CaCO₃, Ca(NO₃)₂, Ca(OH)₂, CaC₂O₄, Ca(CH₃COO)₂.H₂O, Ca(OCH₃)₂, Ca(OC₂H₅)₂, Ca(OC₃H₇)₂, Ca(OC₄H₉)₂, MgCl₂, MgCO₃, Mg(NO₃), Mg(OH)₂, MgC₂O₄, Mg(OCH₃)₂, Mg(OC₂H₅)₂, Mg(OC₃H₇)₂, Mg(OC₄H₉)₂, Mg(C₁₁H₁₉O₂)₂, Bi₂O₃, NaBiO₃, BiCl₃, BiOCl, Bi(NO₃)₃, Bi(OH)₃, Bi(OC₂H₅)₃, Bi(OC₃H₇), Bi(OC₅H₁₁)₃, Bi(C₆H₅)₃, Bi(C₁₁H₁₉O₂)₃, PbO, PbCl₂, PbB₂O₄, PbCO₃, Pb(NO₃)₂, PbC₂O₄, Pb(CH₃COO)₂, Pb(OC₃H₇)₂, Pb(C₁₁H₁₉O₂)₂, Sb₂O₃, SbCl₃, SbOCl, Sb(OCH₃)₃, Sb(OC₂H₅)₃, Sb(OC₃H₇), Sb(OC₄H₉)₃, KMnO₄, NaMnO₄, Ca(MnO₄)₂, Bi₂Mn₄O₁₀, low-melting-point glass (softening point: 500 to 800° C.), etc. Of these, a sodium compound (e.g., NaCl), a potassium compound (e.g., KCl), and a bismuth compound (e.g., Bi₂O₃) are preferred.

A sheet-like compact (including a tape-like or thin compact) is formed from the aforementioned raw material powder particles through any appropriate forming method. No particular limitation is imposed on the forming method, and, for example, a conventionally well known forming method may be employed. Specifically, the compact may be formed through, for example, any of the following forming methods:
doctor blade method;
screen printing;
drum dryer method (specifically, a slurry of raw material powder particles is applied onto a heated drum, and then the dried material is scraped off with a scraper);
disk dryer method (specifically, a slurry of raw material powder particles is applied onto a heated disk surface, and then the dried material is scraped off with a scraper); and
extrusion molding in which clay containing raw material powder particles is extruded through a nozzle having a slit. A formed compact obtained through any of the aforementioned forming methods may be further pressed with, for example, a roller, so as to increase the density of the compact.

Of these forming methods, the doctor blade method is preferred, since it can form a uniform sheet-like compact. In the doctor blade method, a slurry is applied onto a flexible plate (e.g., an organic polymer plate, such as a polyethylene terephthalate (PET) film), and the applied slurry is dried and solidified into a compact. Then, the compact is separated from the plate, to thereby form a green compact. Preferably, the slurry is prepared so as to have a viscosity of 500 to 4,000 mPa·s and is defoamed under reduced pressure.

The sheet-like compact preferably has a thickness of 0.5 to 100 μm, more preferably 1 to 50 μm, much more preferably 5 to 30 μm. Grain growth in a thickness direction of the sheet-like compact can be controlled by appropriately regulating the thickness of the sheet. Thus, since almost the entire surface of the compact is formed by the surfaces of crystal grains, and the grains are exposed to air in a large area, oxygen is readily incorporated into the grains. Therefore, a favorable crystalline product having oxygen defects in as small an amount as possible can be synthesized.

A hollow particulate compact (which may be regarded as a sheet-like compact in a broad sense) may be formed by appropriately regulating the conditions of a spray dryer. A roll-like compact may be formed through, for example, the drum dryer method.

A casting method such as gel cast molding may be employed for forming a sheet-like compact. A compact formed through such a method may also be regarded as a sheet-like compact in a broad sense.

(ii) First firing (thermal treatment) step: A compact obtained through the aforementioned forming step is fired (thermally treated) at 1,000 to 1,300° C. This step produces a fired compact formed of large-sized grains of manganese oxide (Mn₃O₄) into which lithium has not yet been incorporated. No particular limitation is imposed on the firing method, but preferably, there is employed a firing method in which sheet-like compacts are separately placed on a setter so that the area of overlap between the sheet-like compacts is reduced, or a method in which a sheet-like compact is crumpled and fired while it is placed in an uncovered sagger. Firing may be carried out in an oxygen atmosphere (high oxygen partial pressure) (in this case, the oxygen partial pressure is preferably, for example, 50% or more of the pressure of the firing atmosphere).

(iii) Crushing and classification step: A fired compact obtained through the aforementioned firing step is subjected to wet or dry crushing and classification, to thereby produce powder of manganese oxide (Mn₃O₄) particles having an intended size into which lithium has not yet been incorporated. This crushing and classification step may be carried out after the below-described second firing step.

No particular limitation is imposed on the crushing method, and crushing may be carried out by, for example, pressing the fired compact onto a mesh or screen having an opening size of 10 to 100 μm. Alternatively, crushing may be carried out by means of, for example, a pot mill, a bead mill, a hammer mill, or a jet mill. No particular limitation is imposed on the classification method, and classification may be carried out through, for example, elutriation or sieving by use of a mesh having an opening size of 5 to 100 μm. Alternatively, classification may be carried out by means of, for example, an airflow classifier, a sieve classifier, or an elbow jet classifier.

(iv) Second firing step: The manganese oxide fired compact of large particle size obtained through the aforementioned firing step (also through the aforementioned crushing and classification step) and a lithium compound are mixed in specific proportions, and the resultant mixture is fired (thermally treated) at 500 to 800° C. Through this step, lithium is incorporated into the particles, and spinel-type lithium manganate having a large particle size is produced while occurrence of oxygen defects is suppressed to a minimum possible extent.

### 3. Specific Examples

Next will be described in detail specific examples of the above-described production method, and the results of evaluation of particles produced through the production methods of the specific examples.

### 3-1. Production Method

(i) Forming Step

Raw material powder particles containing manganese compound particles (optionally containing a compound of a substitution element and/or a grain growth promoting aid) (100 parts by weight) were mixed with an organic solvent (mixture of toluene and an equiamount of isopropyl alcohol) serving as a dispersion medium (100 parts by weight), polyvinyl butyral (trade name “S-lec (registered trademark) BM-2,” product of Sekisui Chemical Co. Ltd.) serving as a binder (10 parts by weight), a plasticizer (trade name “DOP,” product of Kurogane Kasei Co., Ltd.) (4 parts by weight), and a dispersant (trade name “Rheodol (registered trademark) SP-030,” product of Kao Corporation) (2 parts by weight), to thereby prepare a slurry for forming. The thus-prepared slurry was stirred under reduced pressure for defoaming, so that the viscosity of the slurry was adjusted to 4,000 mPa·s.

In the case of incorporation of a compound of a substitution element and/or a grain growth promoting aid, specific amounts of manganese compound particles and the substitution element compound and/or the grain growth promoting aid were weighed, and the thus-weighed materials and the aforementioned dispersion medium were placed in a cylindrical wide-mouthed bottle made of a synthetic resin and subjected to wet-mixing and crushing by means of a ball mill (zirconia balls having a diameter of 5 mm) for 16 hours. Thereafter, the aforementioned binder, etc. were added to and mixed with the above-crushed product.

The thus-prepared slurry was applied onto a PET film and formed into a sheet-like compact through the doctor blade method so that the compact had an intended thickness after drying.

(ii) First Firing (Thermal Treatment) Step

A 300 mm square piece was cut out from the sheet-like compact separated from the PET film by means of a cutter, and the piece was crumpled and placed in a sagger made of alumina (dimensions: 90 mm×90 mm×60 mm in height). Thereafter, degreasing was carried out under an uncovered condition at 600° C. for two hours, followed by firing.

(iii) Crushing and Classification Step

The thus-fired ceramic sheet was crushed in a polypropylene pot (volume: 1 L) by means of nylon balls (diameter: 10 mm) for 10 hours, to thereby produce powder of large-sized single-grain particles. The powder obtained through crushing was dispersed in ethanol, and then subjected to ultrasonic treatment (38 kHz, 5 minutes) by means of an ultrasonic cleaner. Thereafter, powder particles were caused to pass through a polyester mesh having an average opening size of 5 μm, and particles remaining on the mesh were recovered, to thereby remove particles (size: 5 μm or less) which had been formed during firing or crushing.

(iv) Second Firing (Thermal Treatment) Step

Powder particles of intended size obtained through the aforementioned crushing and classification step were mixed with a lithium compound in specific proportions, and the mixture was thermally treated under specific conditions (temperature, time, and firing atmosphere, which will be described hereinbelow), to thereby produce spinel-type lithium manganate particles employed as cathode active material particles 22a.

### 3-2. Evaluation Method

FIG. 4 is a side sectional view of the schematic configuration of a coin cell 1c for evaluating spinel-type lithium manganate particles (cathode active material particles 22a shown in FIG. 3) produced through one embodiment of the production method of the present invention.

The configuration of the coin cell 1c for evaluation use shown in FIG. 4 will next be described. The coin cell lc was fabricated as follows. A cathode current collector 21, a cathode layer 22, a separator 4, an anode layer 31, and an anode current collector 32 were stacked in this order. The resultant stack and an electrolyte were liquid-tightly sealed in a cell casing 10 (including a cathode container 11, an anode container 12, and an insulation gasket 13).

Specifically, spinel-type lithium manganate particles obtained through the aforementioned production method (cathode active material) (5 mg), acetylene black serving as an electrically conductive agent, and polytetrafluoroethylene (PTFE) serving as a binder were mixed in proportions by mass of 5:5:1, to thereby prepare a cathode material. The thus-prepared cathode material was placed on an aluminum mesh (diameter: 15 mm) and press-formed at 10 kN by means of a pressing machine, to thereby form the cathode layer 22.

The coin cell 1c was fabricated by use of the above-formed cathode layer 22; an electrolytic solution; the anode layer 31 formed of a lithium metal plate; the anode current collector 32 formed of a stainless steel plate; and the separator 4 formed of a lithium ion permeable polyethylene film. The electrolytic solution was prepared as follows: ethylene carbonate (EC) was mixed with an equivolume of diethyl carbonate (DEC) to thereby prepare an organic solvent, and LiPF₆ was dissolved in the organic solvent at a concentration of 1 mol/L.

(A) Initial Capacity (mAh/g)

One cycle consists of the following charge and discharge operations at a test temperature of 20° C.: constant-current charge is carried out at 0.1 C rate of current until the cell voltage becomes 4.3 V; subsequently, constant-voltage charge is carried out under a current condition of maintaining the cell voltage at 4.3 V until the current drops to 1/20, followed by 10 minutes rest; and then constant-current discharge is carried out at 1 C rate of current until the cell voltage becomes 3.0 V, followed by 10 minutes rest. A total of three cycles were performed under a condition of 20° C. The discharge capacity in the third cycle was measured, and the thus-measured capacity was employed as initial capacity.

### (B) Rate Characteristic (%)

One cycle consists of the following charge and discharge operations at a test temperature of 20° C.: constant-current charge is carried out at 0.1 C rate of current until the cell voltage becomes 4.3 V; subsequently, constant-voltage charge is carried out under a current condition of maintaining the cell voltage at 4.3 V until the current drops to 1/20, followed by 10 minutes rest; and then constant-current discharge is carried out at 0.1 C rate of current until the cell voltage becomes 3.0 V, followed by 10 minutes rest. A total of three cycles were performed under a condition of 20° C. The discharge capacity in the third cycle was measured, and the thus-measured capacity was employed as discharge capacity C_{(0.1C)}.

One cycle consists of the following charge and discharge operations at a test temperature of 20° C.: constant-current charge is carried out at 0.1 C rate of current until the cell voltage becomes 4.3 V; subsequently, constant-voltage charge is carried out under a current condition of maintaining the cell voltage at 4.3 V until the current drops to 1/20, followed by 10 minutes rest; and then constant-current discharge is carried out at 10 C rate of current until the cell voltage becomes 3.0 V, followed by 10 minutes rest. A total of three cycles were performed under a condition of 20° C. The discharge capacity in the third cycle was measured, and the thus-measured capacity was employed as discharge capacity C_{(10C)}. Rate characteristic (%) (capacity maintenance percentage) was defined as a value calculated by dividing the discharge capacity C_{(10C)} by the discharge capacity C_{(0.1C)}.

### (C) Cycle Characteristic (%)

The above-produced cell was subjected to cyclic charge-discharge at a test temperature of 45° C. The cyclic charge-discharge repeats: charge at 1 C rate of constant current and constant voltage until 4.3 V is reached, and discharge at 1 C rate of constant current until 3.0 V is reached. Cycle characteristic (%) (durability) was defined as a value calculated by dividing the discharge capacity of the cell as measured after 100 repetitions of cyclic charge-discharge by the initial capacity of the cell.

### 3-3. Evaluation Results

### Example 1

### No Substitution Element Other Than Lithium: Li_{1.1}Mn_{1.9}O₄

Bi₂O₃ (particle size: 0.3 μm, product of Taiyo Koko Co., Ltd.) serving as a grain growth promoting aid (20 wt. %) was added to MnO₂ powder (product of Tosoh Corporation, electrolytic manganese dioxide, FM grade, average particle size: 5 μm, purity: 95%) serving as a raw material (manganese compound), and these materials were mixed with the aforementioned dispersion medium, binder, plasticizer, and dispersant, to thereby prepare a slurry. The thus-prepared slurry was formed into a sheet-like compact (thickness: 20 μm) in a manner similar to that described above, and the sheet-like compact was fired in air at 1,000° C. for 10 hours. After firing, the crystal phase of the raw material was changed to Mn₃O₄.

Mn₃O₄ powder obtained through the crushing and classification step was mixed with Li₂CO₃ powder (product of Kanto Chemical Co., Inc.) so as to attain a composition of Li_{1.1}Mn_{1.9}O₄ after thermal treatment (lithium incorporation). The mixture was thermally treated in an oxygen atmosphere at 700° C. for 10 hours for lithium incorporation. The resultant crystalline powder particles were mixed with hydrochloric acid and pressure-decomposed to thereby prepare a solution sample, and the sample was analyzed by means of an ICP emission spectrophotometer (trade name: ULTIMA2, product of Horiba, Ltd.) for quantification of lithium and manganese. As a result, the lithium-incorporated powder was found to have a composition of Li_{1.1}Mn_{1.9}O₄.

The crystal phase of MnO₂, which has a tetragonal rutile structure, is changed at 530° C. to α-Mn₂O₃, which has a cubic scandium oxide-type structure, and further changed at 940° C. (at 1,090° C. in an oxygen atmosphere) to Mn₃O₄, which has a tetragonal spinel structure. Lithium is effectively incorporated into Mn₃O₄ through thermal treatment at a relatively low temperature, since Mn₃O₄ has a spinel structure similar to that of LiMn₂O₄ (cubic spinel structure).

Table 2 shows the results of experiments in which production conditions were changed as shown in Table 1 with respect to the aforementioned conditions employed in Example 1.

TABLE 1

| | Formed compact | | | | | | | After crushing/ | | | | |
|---|---|---|---|---|---|---|---|---|---|---|---|---|
| | | Grain growth | | | First firing | | | classification | Second firing | | | |
| | | promoting aid | | | Firing | | | Average primary | | Firing | | |
| | Mn raw | | Amount | Thickness | temp. | Holding | Firing | particle size of | Li raw | temp. | Holding | Firing |
| | material | Material | (wt. %) | (μm) | (° C.) | time (h) | atm. | Mn₃O₄ (μm) | material | (° C.) | time (h) | atm. |
| Comp. Ex. 1 | MnO₂ | Bi₂O₃ | 10 | — | 1,100 | 10 | Oxygen | 10 | LiOH | 700 | 10 | Oxygen |
| (No | | | | | | | | | | | | |
| forming step) | | | | | | | | | | | | |
| Ex. B1 | MnO₂ | KCl | 20 | 5 | 850 | 10 | Oxygen | 3 | LiOH | 700 | 10 | Oxygen |
| Ex. B2 | Mn₃O₄ | Bi₂O₃ | 10 | 20 | 1,100 | 10 | Oxygen | 10 | Li₂CO₃ | 900 | 5 | Air |
| Ex. B3 | MnCO₃ | NaCl | 20 | 20 | 1,500 | 10 | Air | 20 | Li₂O | 700 | 10 | Oxygen |
| Ex. B4 | MnO₂ | NaCl | 5 | 40 | 1,200 | 5 | Air | 15 | LiCl | 450 | 5 | Air |
| Ex. B5 | MnO₂ | Bi₂O₃ | 10 | 0.5 | 1,000 | 5 | Air | 7 | LiOH | 650 | 10 | Air |
| Ex. B6 | MnCO₃ | NaCl | 10 | 120 | 1,000 | 5 | Air | 25 | Li₂CO₃ | 650 | 10 | Air |
| Ex. 1 | MnO₂ | Bi₂O₃ | 20 | 20 | 1,000 | 10 | Air | 10 | LiOH | 700 | 5 | Oxygen |
| Ex. 2 | Mn₃O₄ | NaCl | 5 | 30 | 1,200 | 5 | Air | 15 | Li₂CO₃ | 700 | 10 | Oxygen |
| Ex. 3 | MnCO₃ | None | None | 10 | 1,200 | 10 | Oxygen | 10 | Li₂O | 600 | 5 | Air |
| Ex. 4 | MnO₂ | KCl | 10 | 15 | 1,100 | 10 | Oxygen | 10 | LiCl | 650 | 10 | Oxygen |
| Ex. 5 | Mn₃O₄ | NaCl, KCl | 5 each | 2 | 1,100 | 10 | Air | 10 | Li₂CO₃ | 650 | 5 | Air |
| Ex. 6 | MnCO₃ | None | None | 50 | 1,200 | 20 | Oxygen | 15 | Li₂O, LiOH | 700 | 10 | Oxygen |
| Ex. 7 | Mn₃O₄ | Bi₂O₃, | 5 each | 20 | 1,200 | 5 | Air | 15 | Li₂CO₃, | 600 | 10 | Air |
| | | NaCl | | | | | | | LiOH | | | |

TABLE 2

| | Cell characteristics | | |
|---|---|---|---|
| | | | Cycle |
| | Initial capacity | Rate characteristic | characteristic |
| | (mAh/g) | (%) | (%) |
| Comp. Ex. 1 | 100 | 80 | 85 |
| (No forming | | | |
| step) | | | |
| Ex. B1 | 104 | 94 | 90 |
| Ex. B2 | 101 | 85 | 89 |
| Ex. B3 | 103 | 85 | 88 |
| Ex. B4 | 100 | 84 | 88 |
| Ex. B5 | 104 | 95 | 93 |
| Ex. B6 | 105 | 85 | 95 |
| Ex. 1 | 103 | 90 | 98 |
| Ex. 2 | 104 | 89 | 99 |
| Ex. 3 | 104 | 90 | 98 |
| Ex. 4 | 105 | 89 | 98 |
| Ex. 5 | 104 | 90 | 98 |
| Ex. 6 | 105 | 87 | 97 |
| Ex. 7 | 104 | 90 | 98 |

As shown in Tables 1 and 2, Comparative Example 1 corresponds to the case where a sheet forming step was not carried out. Specifically, in Comparative Example 1, a powder mixture prepared by adding Bi₂O₃ (10 wt. %) to MnO₂ was fired in an oxygen atmosphere at 1,100° C. for 10 hours, and LiOH was added to the thus-fired powder, followed by thermal treatment in an oxygen atmosphere at 700° C. for 10 hours.

As shown in Tables 1 and 2, favorable initial capacity, rate characteristic, and cycle characteristic were attained in Examples 1 to 7, in which two-step firing was carried out; specifically, a sheet-like compact formed through the forming step was fired through the first firing step at 1,000 to 1,300° C., and subsequently a mixture of the thus-fired material (raw material powder particles into which lithium had not yet been incorporated) and a lithium compound was fired (thermally treated) the second firing step at 500 to 800° C.

Thus, according to the production method of the present embodiment, in which the sheet-like compact is subjected to two-step firing (provisional firing and thermal treatment for lithium incorporation), occurrence of oxygen defects can be suppressed to a minimum possible extent by causing oxygen to be readily incorporated into crystal grains, and the resultant particles exhibit excellent characteristics and high durability, as compared with conventional cases. In contrast, in Comparative Example 1, in which only two-step firing was carried out without performing a sheet forming step, rate characteristic and cycle characteristic were lowered.

In Example B1, in which the first firing step was carried out at a relatively low firing temperature, grain growth was relatively insufficient (which is apparent from a small particle size of Mn₃O₄ after crushing/classification), and cycle characteristic was lowered. Meanwhile, in Example B3, in which the first firing step was carried out at a relatively high firing temperature, rate characteristic and cycle characteristic were relatively lowered. Conceivably, this is attributed to the fact that oxygen defects were generated in the first firing step due to high firing temperature, and the oxygen defects were relatively insufficiently reduced in the second firing step, although it was carried out in an oxygen atmosphere. In Example B2 or B4, in which the second firing step was carried out at an inappropriate firing temperature, rate characteristic and cycle characteristic were relatively lowered.

In Example B5, in which the sheet-like compact was formed to have a relatively small thickness, grain growth was insufficient, and thus cycle characteristic was relatively lowered. In Example B6, in which the sheet-like compact was formed to have a relatively large thickness, crystallinity was deteriorated upon crushing, and thus rate characteristic and durability were relatively lowered.

Tables 3 and 4 show the results of experiments performed on a composition of lithium manganate in which a portion of manganese was substituted by aluminum (specifically Li_{1.08}Al_{0.09}Mn_{1.83}O₄) (Table 3 shows production conditions, and Table 4 shows evaluation results). Tables 5 and 6 show the results of experiments performed on a composition of lithium manganate in which a portion of manganese was substituted by magnesium (specifically Li_{1.08}Mg_{0.06}Mn_{1.86}O₄) (Table 5 shows production conditions, and Table 6 shows evaluation results). As is clear from Tables 3 to 6, results obtained in the cases of these compositions are similar to those obtained in the case of the composition having no substitution element other than lithium.

TABLE 3

| | Formed compact | | | | | | | After crushing/ | | | | |
|---|---|---|---|---|---|---|---|---|---|---|---|---|
| | | | Grain growth | | First firing | | | classification | Second firing | | | |
| | | Material for | promoting aid | | Firing | Holding | | Average primary | | Firing | Holding | |
| | Mn raw | substitution | | Amount | temp. | time | Firing | particle size of | Li raw | temp. | time | Firing |
| | material | element | Material | (wt. %) | (° C.) | (h) | atm. | Mn₃O₄ (μm) | material | (° C.) | (h) | atm. |
| Comp. Ex. 2 | MnO₂ | Al(OH)₃ | Bi₂O₃ | 10 | 1,100 | 10 | Oxygen | 10 | LiOH | 700 | 10 | Oxygen |
| (No forming | | | | | | | | | | | | |
| step) | | | | | | | | | | | | |
| Ex. B7 | MnO₂ | Al(OH)₃ | NaCl | 10 | 850 | 10 | Oxygen | 3 | Li₂CO₃ | 700 | 5 | Oxygen |
| Ex. B8 | Mn₃O₄ | AlOOH | KCl | 5 | 1,100 | 10 | Oxygen | 10 | LiOH | 900 | 10 | Air |
| Ex. B9 | MnCO₃ | Al(OH)₃ | Bi₂O₃ | 10 | 1,500 | 10 | Air | 20 | Li₂CO₃ | 700 | 5 | Oxygen |
| Ex. B10 | MnO₂ | AlOOH | None | None | 1,200 | 5 | Air | 15 | LiOH | 450 | 10 | Air |
| Ex. 8 | MnO₂ | Al(OH)₃ | NaCl | 10 | 1,000 | 10 | Air | 10 | Li₂CO₃ | 700 | 5 | Oxygen |
| Ex. 9 | Mn₃O₄ | AlOOH | KCl | 20 | 1,200 | 5 | Air | 15 | LiOH | 650 | 10 | Air |
| Ex. 10 | MnCO₃ | Al(OH)₃ | Bi₂O₃ | 5 | 1,100 | 10 | Oxygen | 10 | LiCl | 650 | 5 | Oxygen |
| syuEx. 11 | MnO₂ | AlOOH | None | None | 1,200 | 10 | Oxygen | 10 | LiOH | 700 | 10 | Oxygen |
| Ex. 12 | Mn₃O₄ | Al(OH)₃ | NaCl, KCl | 5 each | 1,100 | 10 | Air | 10 | Li₂CO₃ | 700 | 5 | Oxygen |
| Ex. 13 | MnCO₃ | AlOOH | None | None | 1,200 | 10 | Oxygen | 10 | LiCl, | 650 | 10 | Air |
| | | | | | | | | | LiOH | | | |
| Ex. 14 | Mn₃O₄ | AlOOH | Bi₂O₃, NCl | 5 each | 1,200 | 5 | Air | 15 | Li₂CO₃, | 650 | 10 | Air |
| | | | | | | | | | LiOH | | | |

TABLE 4

| | Cell characteristics | | |
|---|---|---|---|
| | | | Cycle |
| | Initial capacity | Rate characteristic | characteristic |
| | (mAh/g) | (%) | (%) |
| Comp. Ex. 2 | 100 | 80 | 85 |
| (No forming | | | |
| step) | | | |
| Ex. B7 | 104 | 94 | 89 |
| Ex. B8 | 102 | 87 | 88 |
| Ex. B9 | 104 | 86 | 90 |
| Ex. B10 | 100 | 85 | 89 |
| Ex. 8 | 104 | 90 | 98 |
| Ex. 9 | 105 | 89 | 99 |
| Ex. 10 | 103 | 90 | 98 |
| Ex. 11 | 104 | 89 | 98 |
| Ex. 12 | 103 | 90 | 98 |
| Ex. 13 | 104 | 89 | 98 |
| Ex. 14 | 103 | 90 | 98 |

TABLE 5

| | Formed compact | | | | | | | After crushing/ | | | | |
|---|---|---|---|---|---|---|---|---|---|---|---|---|
| | | | Grain growth | | First firing | | | classification | Second firing | | | |
| | | Material for | promoting aid | | Firing | Holding | | Average primary | | Firing | Holding | |
| | Mn raw | substitution | | Amount | temp. | time | Firing | particle size of | Li raw | temp. | time | Firing |
| | material | element | Material | (wt. %) | (° C.) | (h) | atm. | Mn₃O₄ (μm) | material | (° C.) | (h) | atm. |
| Comp. Ex. 3 | MnO₂ | Mg(OH)₂ | Bi₂O₃ | 10 | 1,100 | 10 | Oxygen | 10 | LiOH | 700 | 10 | Oxygen |
| (No forming | | | | | | | | | | | | |
| step) | | | | | | | | | | | | |
| Ex. B11 | MnO₂ | Mg(OH)₂ | NaCl | 10 | 850 | 10 | Oxygen | 3 | LiOH | 700 | 5 | Oxygen |
| Ex. B12 | Mn₃O₄ | MgCO₃ | KCl | 5 | 1,100 | 10 | Oxygen | 10 | Li₂CO₃ | 900 | 10 | Air |
| Ex. B13 | MnCO₃ | Mg(OH)₂ | Bi₂O₃ | 10 | 1,500 | 10 | Air | 20 | Li₂O | 700 | 5 | Oxygen |
| Ex. B14 | MnO₂ | MgCO₃ | None | None | 1,200 | 5 | Air | 15 | LiOH | 450 | 10 | Air |
| Ex. 15 | MnO₂ | Mg(OH)₂ | NaCl | 10 | 1,000 | 10 | Air | 10 | Li₂CO₃ | 700 | 5 | Oxygen |
| Ex. 16 | Mn₃O₄ | MgCO₃ | KCl | 20 | 1,200 | 5 | Air | 15 | LiOH | 650 | 10 | Air |
| Ex. 17 | MnCO₃ | Mg(OH)₂ | Bi₂O₃ | 5 | 1,100 | 10 | Oxygen | 10 | Li₂O | 650 | 5 | Oxygen |
| Ex. 18 | MnO₂ | MgCO₃ | None | None | 1,200 | 10 | Oxygen | 10 | LiOCl | 700 | 10 | Oxygen |
| Ex. 19 | Mn₃O₄ | Mg(OH)₂ | NaCl, KCl | 5 each | 1,100 | 10 | Air | 10 | LiOH | 700 | 5 | Oxygen |
| Ex. 20 | MnCO₃ | MgCO₃ | None | None | 1,200 | 10 | Oxygen | 10 | LiCl, Li₂O | 650 | 10 | Air |
| Ex. 21 | Mn₃O₄ | Mg(OH)₂ | Bi₂O₃, NCl | 5 each | 1,200 | 5 | Air | 15 | Li₂CO₃, | 650 | 10 | Air |
| | | | | | | | | | LiOH | | | |

TABLE 6

| | Cell characteristics | | |
|---|---|---|---|
| | | | Cycle |
| | Initial capacity | Rate characteristic | characteristic |
| | (mAh/g) | (%) | (%) |
| Comp. Ex. 3 | 100 | 80 | 85 |
| (No forming | | | |
| step) | | | |
| Ex. B11 | 103 | 93 | 89 |
| Ex. B12 | 101 | 84 | 87 |
| Ex. B13 | 105 | 84 | 89 |
| Ex. B14 | 99 | 85 | 89 |
| Ex. 15 | 103 | 89 | 99 |
| Ex. 16 | 104 | 90 | 98 |
| Ex. 17 | 105 | 89 | 98 |
| Ex. 18 | 103 | 90 | 99 |
| Ex. 19 | 104 | 91 | 98 |
| Ex. 20 | 103 | 90 | 99 |
| Ex. 21 | 105 | 89 | 98 |

Tables 7 and 8 show the results of experiments performed on a composition of lithium manganate in which the lithium content was reduced for attaining high capacity, as compared with the case of Example 1 (specifically Li_{1.06}Mn_{1.94}O₄) (Table 7 shows production conditions, and Table 8 shows evaluation results). Tables 9 and 10 show the results of experiments performed on a composition of lithium manganate of low lithium content in which a portion of manganese was substituted by aluminum (specifically Li_{1.03}Al_{0.04}Mn_{1.93}O₄) (Table 9 shows production conditions, and Table 10 shows evaluation results). Tables 11 and 12 show the results of experiments performed on a composition of lithium manganate of low lithium content in which a portion of manganese was substituted by magnesium (specifically Li_{1.04}Mg_{0.02}Mn_{1.94}O₄) (Table 11 shows production conditions, and Table 12 shows evaluation results).

In the case of such a composition for attaining high capacity, generally, oxygen defects are likely to be generated, which particularly causes a problem in terms of durability. However, as shown in Tables 7 to 12, even in the case of such a composition, similar to the aforementioned cases, spinel-type lithium manganate particles exhibiting excellent characteristics and high durability were produced through two-step firing.

TABLE 7

| | Formed compact | | | | | | After crushing/ | | | | |
|---|---|---|---|---|---|---|---|---|---|---|---|
| | | Grain growth | | First firing | | | classification | Second firing | | | |
| | | promoting aid | | Firing | Holding | | Average primary | Li | Firing | Holding | |
| | Mn raw | | Amount | temp. | time | Firing | particle size of | raw | temp. | time | Firing |
| | material | Material | (wt. %) | (° C.) | (h) | atm. | Mn₃O₄ (μm) | material | (° C.) | (h) | atm. |
| Comp. Ex. 4 | MnO₂ | Bi₂O₃ | 10 | 1,100 | 10 | Oxygen | 10 | LiOH | 700 | 10 | Oxygen |
| (No forming | | | | | | | | | | | |
| step) | | | | | | | | | | | |
| Ex. B15 | MnO₂ | KCl | 20 | 850 | 10 | Oxygen | 3 | LiOH | 700 | 10 | Oxygen |
| Ex. B16 | Mn₃O₄ | Bi₂O₃ | 10 | 1,100 | 10 | Oxygen | 10 | Li₂CO₃ | 900 | 5 | Air |
| Ex. B17 | MnCO₃ | NaCl | 20 | 1,500 | 10 | Air | 20 | Li₂O | 700 | 10 | Oxygen |
| Ex. B18 | MnO₂ | NaCl | 5 | 1,200 | 5 | Air | 15 | LiCl | 450 | 5 | Air |
| Ex. 22 | MnO₂ | Bi₂O₃ | 20 | 1,000 | 10 | Air | 10 | LiOH | 700 | 5 | Oxygen |
| Ex. 23 | Mn₃O₄ | NaCl | 5 | 1,200 | 5 | Air | 15 | Li₂CO₃ | 700 | 10 | Oxygen |
| Ex. 24 | MnCO₃ | None | None | 1,200 | 10 | Oxygen | 10 | Li₂O | 600 | 5 | Air |
| Ex. 25 | MnO₂ | KCl | 10 | 1,100 | 10 | Oxygen | 10 | LiCl | 650 | 10 | Oxygen |
| Ex. 26 | Mn₃O₄ | NaCl, KCl | 5 each | 1,100 | 10 | Air | 10 | Li₂CO₃ | 650 | 5 | Air |
| Ex. 27 | MnCO₃ | None | None | 1,200 | 10 | Oxygen | 10 | Li₂O, LiOH | 700 | 10 | Oxygen |
| Ex. 28 | Mn₃O₄ | Bi₂O₃, NaCl | 5 each | 1,200 | 5 | Air | 15 | Li₂CO₃, | 600 | 10 | Air |
| | | | | | | | | LiOH | | | |

TABLE 8

| | Cell characteristics | | |
|---|---|---|---|
| | | | Cycle |
| | Initial capacity | Rate characteristic | characteristic |
| | (mAh/g) | (%) | (%) |
| Comp. Ex. 4 | 115 | 78 | 79 |
| (No forming | | | |
| step) | | | |
| Ex. B15 | 120 | 92 | 88 |
| Ex. B16 | 118 | 82 | 85 |
| Ex. B17 | 119 | 85 | 87 |
| Ex. B18 | 115 | 82 | 88 |
| Ex. 22 | 120 | 89 | 97 |
| Ex. 23 | 121 | 88 | 97 |
| Ex. 24 | 120 | 87 | 98 |
| Ex. 25 | 118 | 88 | 97 |
| Ex. 26 | 119 | 89 | 97 |
| Ex. 27 | 118 | 90 | 98 |
| Ex. 28 | 119 | 89 | 97 |

TABLE 9

| | Formed compact | | | | | | | After crushing/ | | | | |
|---|---|---|---|---|---|---|---|---|---|---|---|---|
| | | Material | Grain growth | | First firing | | | classification | Second firing | | | |
| | | for | promoting aid | | Firing | Holding | | Average primary | | Firing | Holding | |
| | Mn raw | substitution | | Amount | temp. | time | Firing | particle size of | Li raw | temp. | time | Firing |
| | material | element | Material | (wt. %) | (° C.) | (h) | atm. | Mn₃O₄ (μm) | material | (° C.) | (h) | atm. |
| Comp. Ex. 5 | MnO₂ | Al(OH)₃ | Bi₂O₃ | 10 | 1,100 | 10 | Oxygen | 10 | LiOH | 700 | 10 | Oxygen |
| (No forming | | | | | | | | | | | | |
| step) | | | | | | | | | | | | |
| Ex. B19 | MnO₂ | Al(OH)₃ | NaCl | 10 | 850 | 10 | Oxygen | 3 | Li₂CO₃ | 700 | 5 | Oxygen |
| Ex. B20 | Mn₃O₄ | AlOOH | KCl | 5 | 1,100 | 10 | Oxygen | 10 | LiOH | 900 | 10 | Air |
| Ex. B21 | MnCO₃ | Al(OH)₃ | Bi₂O₃ | 10 | 1,500 | 10 | Air | 20 | Li₂CO₃ | 700 | 5 | Oxygen |
| Ex. B22 | MnO₂ | AlOOH | None | None | 1,200 | 5 | Air | 15 | LiOH | 450 | 10 | Air |
| Ex. 29 | MnO₂ | Al(OH)₃ | NaCl | 10 | 1,000 | 10 | Air | 10 | Li₂CO₃ | 700 | 5 | Oxygen |
| Ex. 30 | Mn₃O₄ | AlOOH | KCl | 20 | 1,200 | 5 | Air | 15 | LiOH | 650 | 10 | Air |
| Ex. 31 | MnCO₃ | Al(OH)₃ | Bi₂O₃ | 5 | 1,100 | 10 | Oxygen | 10 | LiCl | 650 | 5 | Oxygen |
| Ex. 32 | MnO₂ | AlOOH | None | None | 1,200 | 10 | Oxygen | 10 | LiOH | 700 | 10 | Oxygen |
| Ex. 33 | Mn₃O₄ | Al(OH)₃ | NaCl, KCl | 5 each | 1,100 | 10 | Air | 10 | Li₂CO₃ | 700 | 5 | Oxygen |
| Ex. 34 | MnCO₃ | AlOOH | None | None | 1,200 | 10 | Oxygen | 10 | LiCl, | 650 | 10 | Air |
| | | | | | | | | | LiOH | | | |
| Ex. 35 | Mn₃O₄ | AlOOH | Bi₂O₃, NCl | 5 each | 1,200 | 5 | Air | 15 | Li₂CO₃, | 650 | 10 | Air |
| | | | | | | | | | LiOH | | | |

TABLE 10

| | Cell characteristics | | |
|---|---|---|---|
| | | | Cycle |
| | Initial capacity | Rate characteristic | characteristic |
| | (mAh/g) | (%) | (%) |
| Comp. Ex. 5 | 115 | 78 | 79 |
| (No forming | | | |
| step) | | | |
| Ex. B19 | 121 | 94 | 88 |
| Ex. B20 | 119 | 83 | 84 |
| Ex. B21 | 120 | 85 | 88 |
| Ex. B22 | 115 | 84 | 89 |
| Ex. 29 | 120 | 89 | 98 |
| Ex. 30 | 119 | 90 | 98 |
| Ex. 31 | 120 | 90 | 97 |
| Ex. 32 | 122 | 91 | 98 |
| Ex. 33 | 119 | 88 | 98 |
| Ex. 34 | 122 | 90 | 97 |
| Ex. 35 | 121 | 91 | 98 |

TABLE 11

| | Formed compact | | | | | | | After crushing/ | | | | |
|---|---|---|---|---|---|---|---|---|---|---|---|---|
| | | | Grain growth | | First firing | | | classification | Second firing | | | |
| | | Material for | promoting aid | | Firing | Holding | | Average primary | | Firing | Holding | |
| | Mn raw | substitution | | Amount | temp. | time | Firing | particle size of | Li raw | temp. | time | Firing |
| | material | element | Material | (wt. %) | (° C.) | (h) | atm. | Mn₃O₄ (μm) | material | (° C.) | (h) | atm. |
| Comp. Ex. 6 | MnO₂ | Mg(OH)₂ | Bi₂O₃ | 10 | 1,100 | 10 | Oxygen | 10 | LiOH | 700 | 10 | Oxygen |
| (No forming | | | | | | | | | | | | |
| step) | | | | | | | | | | | | |
| Ex. B23 | MnO₂ | Mg(OH)₂ | NaCl | 10 | 850 | 10 | Oxygen | 3 | LiOH | 700 | 5 | Oxygen |
| Ex. B24 | Mn₃O₄ | MgCO₃ | KCl | 5 | 1,100 | 10 | Oxygen | 10 | Li₂CO₃ | 900 | 10 | Air |
| Ex. B25 | MnCO₃ | Mg(OH)₂ | Bi₂O₃ | 10 | 1,500 | 10 | Air | 20 | Li₂O | 700 | 5 | Oxygen |
| Ex. B26 | MnO₂ | MgCO₃ | None | None | 1,200 | 5 | Air | 15 | LiOH | 450 | 10 | Air |
| Ex. 36 | MnO₂ | Mg(OH)₂ | NaCl | 10 | 1,000 | 10 | Air | 10 | Li₂CO₃ | 700 | 5 | Oxygen |
| Ex. 37 | Mn₃O₄ | MgCO₃ | KCl | 20 | 1,200 | 5 | Air | 15 | LiOH | 650 | 10 | Air |
| Ex. 38 | MnCO₃ | Mg(OH)₂ | Bi₂O₃ | 5 | 1,100 | 10 | Oxygen | 10 | Li₂O | 650 | 5 | Oxygen |
| Ex. 39 | MnO₂ | MgCO₃ | None | None | 1,200 | 10 | Oxygen | 10 | LiOCl | 700 | 10 | Oxygen |
| Ex. 40 | Mn₃O₄ | Mg(OH)₂ | NaCl, KCl | 5 each | 1,100 | 10 | Air | 10 | LiOH | 700 | 5 | Oxygen |
| Ex. 41 | MnCO₃ | MgCO₃ | None | None | 1,200 | 10 | Oxygen | 10 | LiCl, Li₂O | 650 | 10 | Air |
| Ex. 42 | Mn₃O₄ | Mg(OH)₂ | Bi₂O₃, NCl | 5 each | 1,200 | 5 | Air | 15 | Li₂CO₃, | 650 | 10 | Air |
| | | | | | | | | | LiOH | | | |

TABLE 12

| | Cell characteristics | | |
|---|---|---|---|
| | Initial capacity | Rate characteristic | Cycle characteristic |
| | (mAh/g) | (%) | (%) |
| Comp. Ex. 6 | 115 | 78 | 79 |
| (No forming | | | |
| step) | | | |
| Ex. B23 | 119 | 93 | 90 |
| Ex. B24 | 118 | 82 | 87 |
| Ex. B25 | 121 | 84 | 89 |
| Ex. B26 | 115 | 85 | 88 |
| Ex. 36 | 120 | 88 | 97 |
| Ex. 37 | 119 | 89 | 98 |
| Ex. 38 | 121 | 90 | 98 |
| Ex. 39 | 123 | 88 | 97 |
| Ex. 40 | 124 | 90 | 98 |
| Ex. 41 | 119 | 89 | 98 |
| Ex. 42 | 121 | 90 | 98 |

In the case of each composition shown in Tables 3 to 12, the thickness of a sheet-like formed compact was adjusted as in the cases shown above in Tables 1 and 2.

### 3. Modifications

The above-described embodiment and specific examples are, as mentioned above, mere examples of the best mode of the present invention which the applicant of the present invention contemplated at the time of filing the present application. The above-described embodiment and specific examples should not be construed as limiting the invention.

Various modifications to the above-described embodiment and specific examples are possible, so long as the invention is not modified in essence.

Several modifications will next be exemplified. Needless to say, even modifications are not limited to those described below. Limitingly construing the present invention based on the above-described embodiment and the following modifications impairs the interests of an applicant (particularly, an applicant who is motivated to file as quickly as possible under the first-to-file system) while unfairly benefiting imitators, and is thus impermissible.

Needless to say, the constitution of the above-described embodiment and the constitutions of the modifications to be described below are entirely or partially applicable in appropriate combination, so long as no technical inconsistencies are involved.

(1) The present invention is not limited to the constitution which is specifically disclosed in the description of the above embodiments. That is, the application of the present invention is not limited to the specific configurations shown in FIGS. 1, 2, and 4. Also, no particular limitation is imposed on the number of the cathode plates 2, the separators 4, and the anode plates 3 to be stacked together.

(2) The present invention is not limited to the production methods disclosed specifically in the above-described embodiments. For example, a grain growth promoting aid is not necessarily added. The firing step may be performed by means of a rotary kiln. In this case, when a grain growth promoting aid (e.g., a bismuth compound) is added, a component of the aid (e.g., bismuth) is removed more efficiently.

When a bismuth compound is employed as a grain growth promoting aid, the bismuth compound may be suitably a compound of bismuth and manganese (e.g., Bi₂Mn₄O₁₀) (even when Bi₂O₃ is employed, Bi₂Mn₄O₁₀ may be generated in the course of firing). In this case, during firing, bismuth evaporates, and manganese becomes lithium manganate, thereby absorbing lithium excessively present in the form of solid solution. This produces spinel-type lithium manganate (cathode active material) having smaller amounts of impurities.

(3) Needless to say, those modifications which are not particularly referred to are also encompassed in the technical scope of the present invention, so long as the invention is not modified in essence.

Those components which partially constitute means for solving the problems to be solved by the present invention and are operationally or functionally expressed encompass not only the specific structures disclosed above in the description of the aforementioned embodiments and modifications but also any other structures that can implement the operations or functions of the components. Further, the contents (including specifications and drawings) of the prior application and publications cited herein can be incorporated herein as appropriate by reference.

1. A method for producing spinel-type lithium manganate, which is an oxide containing at least lithium and manganese as constituent elements and having a spinel structure, characterized in that the method comprises:
a forming step of forming into a sheet-like compact a raw material containing at least a manganese compound and not containing a lithium compound;
a first firing step of firing the sheet-like compact formed through the forming step; and
a second firing step of firing a mixture of the fired compact obtained through the first firing step and a lithium compound at a temperature lower than the firing temperature employed in the first firing step.

2. A method for producing spinel-type lithium manganate according to claim 1, wherein the first firing step is carried out at a firing temperature of 1,000 to 1,300° C., and the second firing step is carried out at a firing temperature of 500 to 800° C.

3. A method for producing spinel-type lithium manganate according to claim 1, wherein the raw material contains a manganese compound and a grain growth promoting aid having a melting point lower than the firing temperature employed in the first firing step.
